(19) United States
(12) Patent Application Publication
(10) Pub. No.: US 2026/0166934 A1
(43) Pub. Date: Jun. 18, 2026

(54) SYSTEM AND METHOD TO CONNECT HOSES TO A HITCH

(71) Applicant: Torc Robotics, Inc., Blacksburg, VA (US)

(72) Inventors: Nicholas Atanasov, Austin, TX (US); Akshay Pai Raikar, Austin, TX (US); Joseph R. Fox-Rabinovitz, Austin, TX (US)

(21) Appl. No.: 18/978,643

(22) Filed: Dec. 12, 2024

(51) Int. Cl. B60D 1/62; B62D 53/08

(52) U.S. Cl. CPC B60D 1/62; B62D 53/0842

(57) ABSTRACT

A hitch assembly to couple a vehicle and a trailer. The hitch assembly including a hitch defining a head and a body. The body is configured to be mounted with respect to the vehicle. The head defines a slot extending between a first end and an opposite second end and defined by at least an engagement surface. A kingpin defining a body mounted with respect to the trailer, wherein the body is configured to engage with the slot of the hitch and is mounted with respect to the engagement surface of the head. The vehicle and the trailer are in fluid and electrical communication when the kingpin is mounted with respect to the hitch.

### TECHNICAL FIELD

The field of the disclosure relates to the connection of a vehicle and a trailer and, in particular, to connecting air and electrical attachments between a vehicle and a trailer using a hitch assembly.

### BACKGROUND

Traditionally, a vehicle configured to haul a trailer includes some level of user/personal involvement to connect and/or disconnect the trailer from the vehicle. For example, the vehicle is positioned near the trailer and the user manually connects the air and electrical attachments to couple the vehicle and the trailer. However, there remains a need to remove user involvement in connecting air and electrical attachments. The need to decrease the need for user connection/disconnection involvement is increasing with the development of semi-autonomous and fully autonomous vehicles where there is no user available to connect or disconnect the attachments.

Accordingly, there exists a need for a system and a method to enable hitching of a vehicle to a trailer where air and electrical attachments are made without user involvement.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a hitch assembly to couple a vehicle and a trailer. The hitch assembly includes a hitch defining a head and a body. The body is configured to be mounted with respect to the vehicle. The head defines a slot extending between a first end and an opposite second end and defined by at least an engagement surface. A kingpin defining a body mounted with respect to the trailer, wherein the body is configured to engage with the slot of the hitch and is mounted with respect to the engagement surface of the head. The vehicle and the trailer are in fluid and electrical communication when the kingpin is mounted with respect to the hitch.

In another aspect, a method of connecting a trailer with a vehicle is discussed. The trailer includes a kingpin and the vehicle includes a hitch, wherein the kingpin defines a post extending away from the trailer and a body coupled to the post and opposite from the trailer. The hitch defines a body mounted with respect to the vehicle and a head coupled to the body and opposite from the vehicle, wherein the head of the hitch defines a slot defined at least partially by an engagement surface. The method includes aligning the head of the hitch with the body of the kingpin. The method includes sliding the body of the kingpin and the head of the hitch together. The method includes coupling the kingpin and the hitch such that the vehicle and the trailer are movably coupled with each other, wherein the vehicle and the trailer are in fluid and electrical communication when the kingpin is coupled to the hitch.

In yet another aspect, a hitch assembly to couple a vehicle and a trailer includes a hitch defining a head and a body, wherein the body is configured to be mounted with respect to the vehicle. The head defines a slot extending between a first end and an opposite second end and defined by at least an engagement surface, wherein the slot is tapered such that the distance of the slot relative to the engagement surface at the first end is greater than the distance of the slot relative to the engagement surface at the second end. The hitch assembly includes a kingpin defining a body mounted with respect to the trailer, wherein the body is tapered such that the distance of the body at a first end is less than the distance of the body at an opposite second end. The body is configured to engage with the slot of the hitch and is mounted with respect to the engagement surface of the head, wherein the vehicle and the trailer are in fluid and electrical communication when the kingpin is mounted with respect to the hitch.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4 is a cross-sectional view of a detached vehicle including a hitch and a trailer including a kingpin;

FIG. 5 is a cross-sectional view of an attached vehicle including a hitch and a trailer including a kingpin;

FIG. 6 is a cross-sectional view of an assembled hitch assembly;

FIG. 7 is a cross-sectional view taken along line 7-7 of the assembly hitch assembly shown in FIG. 6;

FIG. 8 is a partial perspective view of the hitch shown in FIG. 6;

FIG. 9 is a cross-sectional view of the hitch;

FIG. 10 is a bottom view of the kingpin;

FIG. 11 is a cross-sectional view of the kingpin shown in FIG. 10 taken along line 11-11;

FIG. 12 is a cross-sectional view of the kingpin showing a first arrangement of a fluid opening and an electrical wire;

FIG. 13 is a cross-sectional view of the kingpin showing a second arrangement of a fluid opening and an electrical wire; and

FIG. 14 is a schematic depicting the operation of coupling the vehicle and the trailer of FIGS. 4 and 5 using the hitch assembly of FIG. 6.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

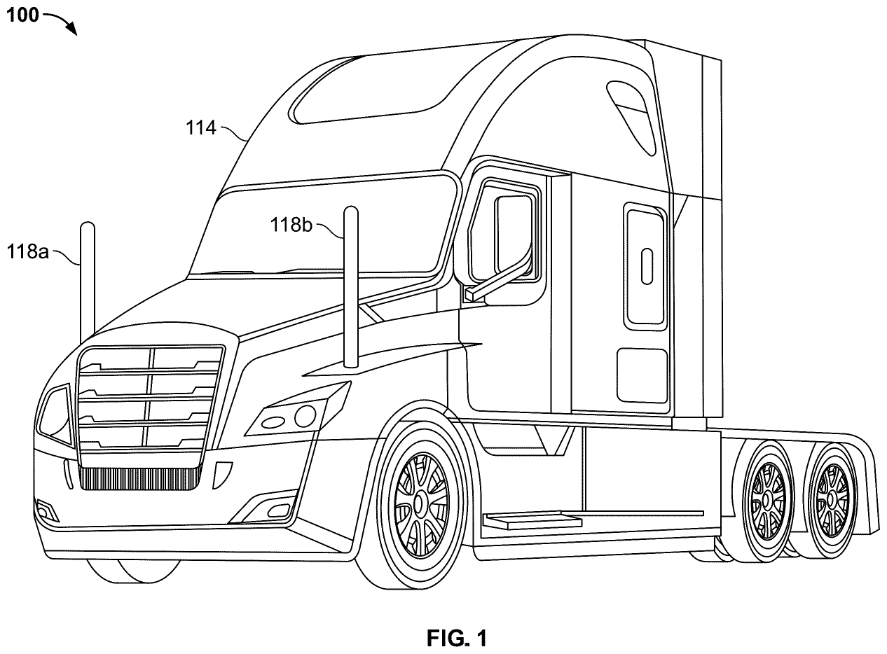

As described herein, the present disclosure is directed to hitch assembly to connect a trailer and a vehicle, such as an autonomous vehicle. Specifically, a hitch assembly that enables engagement and disengagement of hoses with minimal (or without any) user intervention. In an exemplary embodiment, the hitch assembly includes a hitch and a kingpin. Various embodiments in the present disclosure are described with reference to FIGS. 1-13 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114. The vehicle 100 includes an antenna 118, referenced as a pair of antennas 118A, 118B, which are positioned near the front of the vehicle 100. The pair of antennas 118A, 118B may include one or more sensors.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

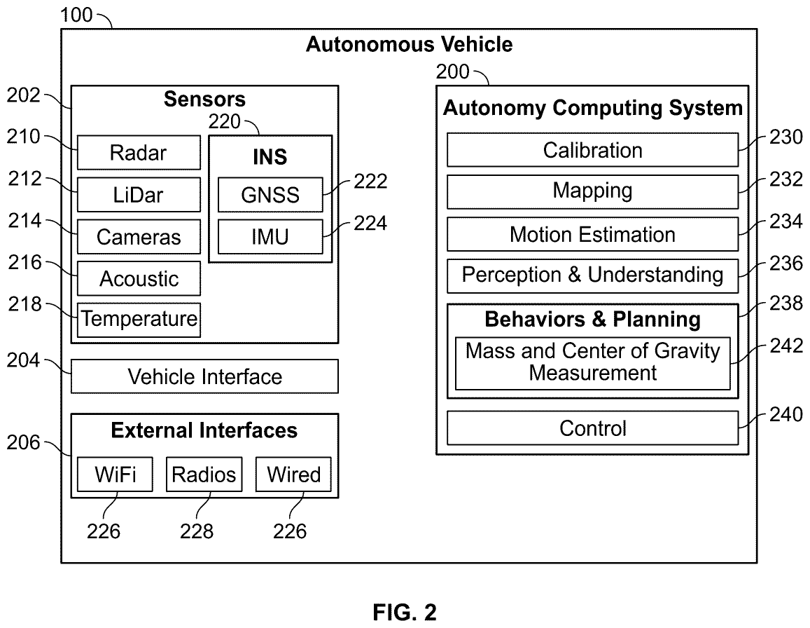

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

In some embodiments, the image data generated by cameras 214 may be transmitted to mission control for one or more of identifying one or more construction markers (or nodes), generating one or more connectivity graphs based upon identified construction markers (or nodes), updating a reference path based upon the one or more connectivity graphs, transmitting the updated reference path to the autonomy vehicle 100 for guiding autonomous vehicle 100 to drive on the updated reference path.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

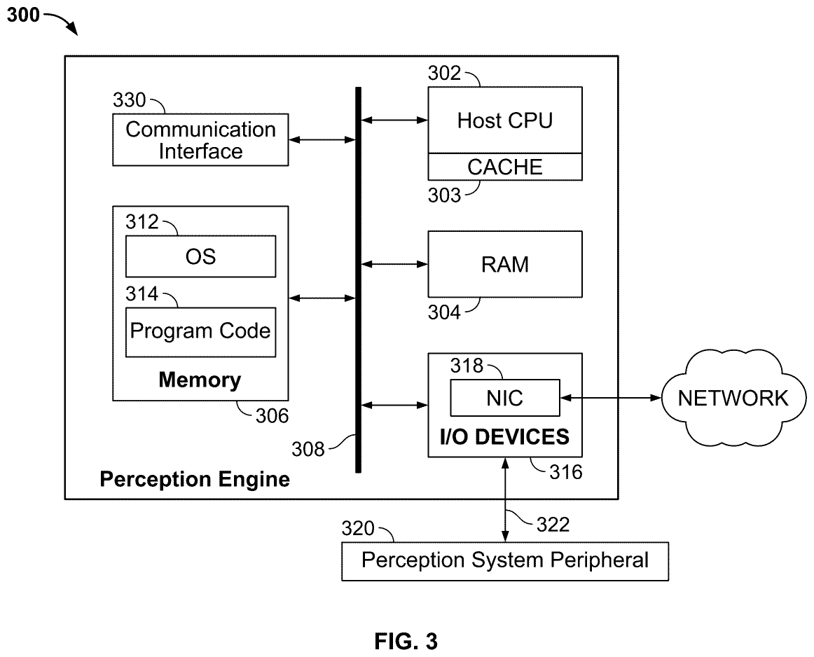

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

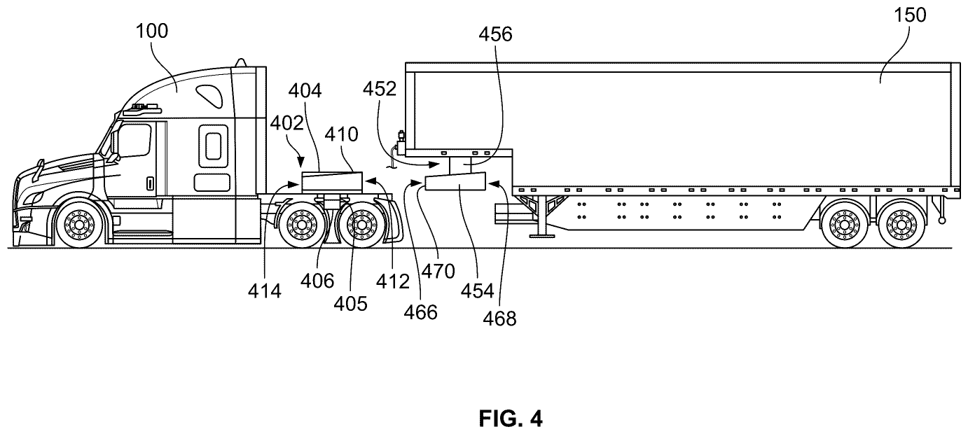

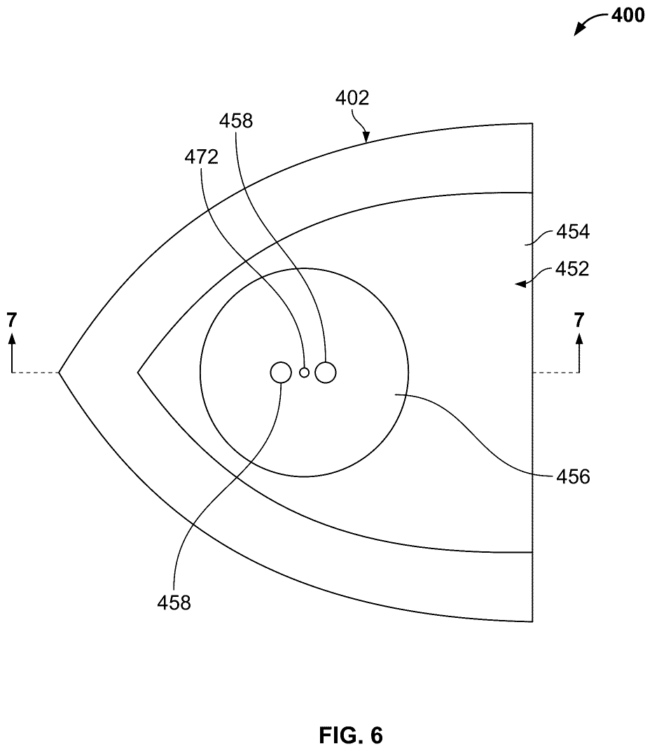

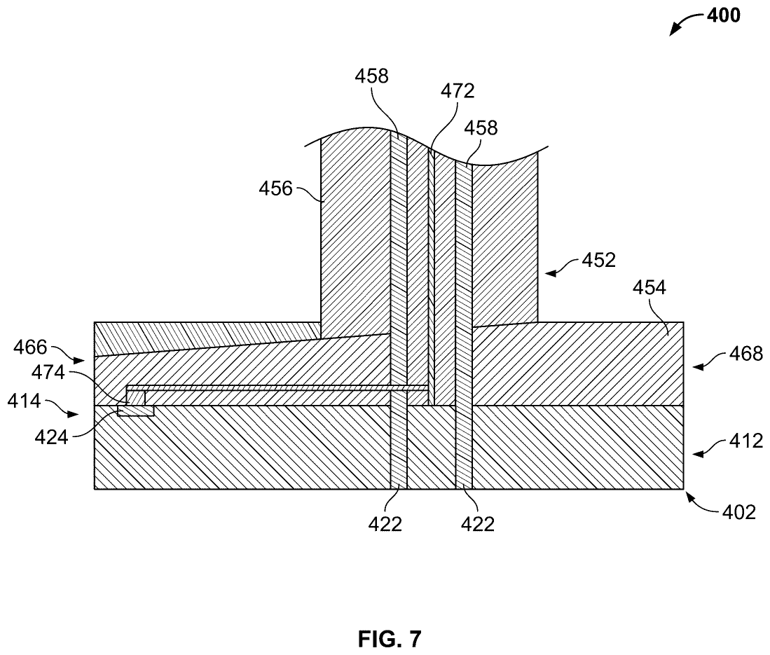

Referring to FIGS. 4-11, the vehicle 100 is removably coupled to a trailer 150 by way of a hitch assembly 400. It should be understood that although the vehicle 100 is removably coupled to a trailer 150 as shown in the figures, alternative trailers/vehicles may be used without departing from the spirit/scope of this disclosure. The hitch assembly 400 includes a hitch 402, commonly referred to as a fifth-wheel hitch, as further shown in FIGS. 4-9, and a kingpin 452, as further shown in FIGS. 4-7 and 10-13. Referring to FIGS. 6 and 7, the hitch assembly 400 may be used to removably couple the vehicle 100, using the hitch 402, to the trailer 150, using the kingpin 452. At least a portion of the hitch 402 is configured to engage with at least a portion of the kingpin 452. The discussion of the hitch assembly 400 will be better understood by discussing the hitch 402 and the kingpin 452 separately.

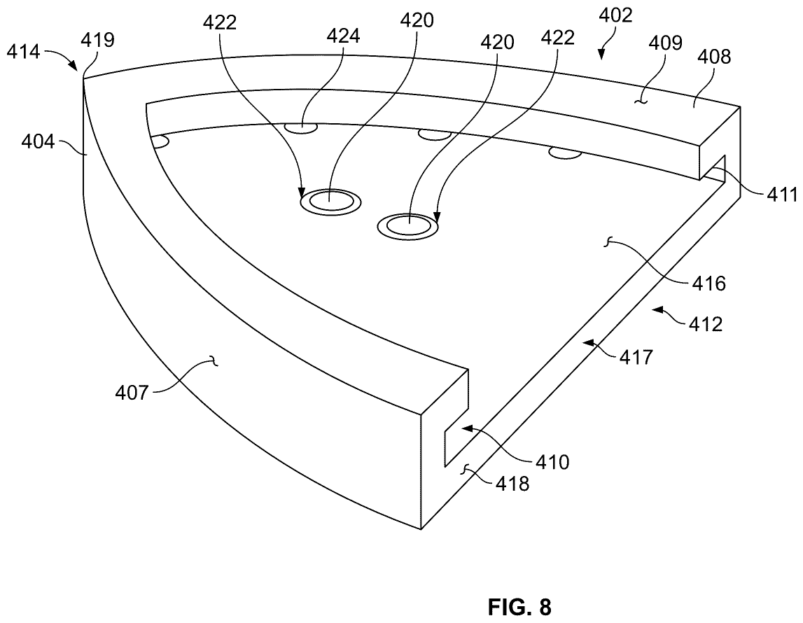

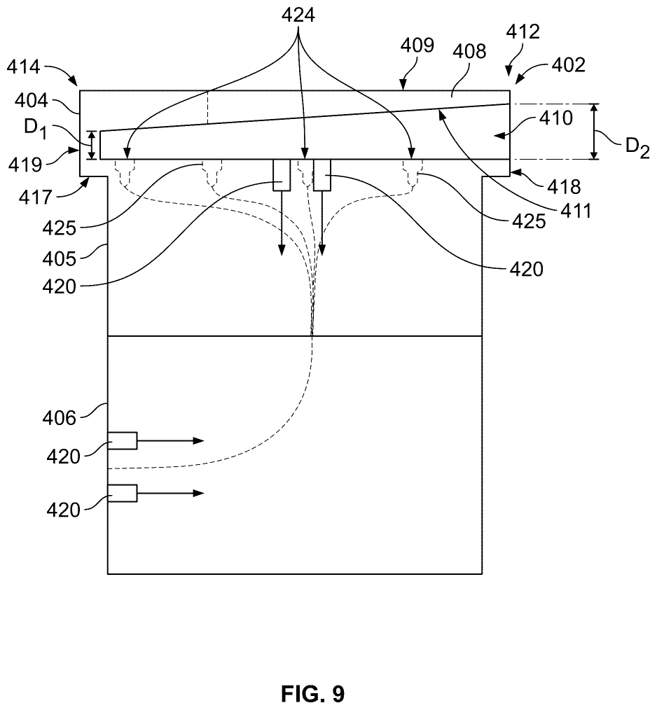

Referring to FIGS. 8 and 9, the hitch 402 defines a head 404 and a body 406. Differentiating between the head 404 and the body 406 provides a more thorough discussion of the hitch 402 but does not expressly indicate two separate components. Instead, the head 402 and the body 406 may be separate components that are combined to produce the hitch 402 or may be sections of the singular component, the hitch 402. For example, at least a portion of the head 404 is configured to engage with at least a portion of the kingpin 452.

The hitch 402 defines a lip 408 that extends at least partially around the periphery of the head 404 and extends in a direction away from outer surface 407. The head 404 defines a engagement surface 416 that is opposite from the lip 408. The engagement surface 416 may be perpendicular or angled relative to the outer surface 407. The lip 408 extends a distance inwardly relative to the outer surface 407 and covers or overhangs above at least a portion of the engagement surface 416. The lip 408 and the engagement surface 416 at least partially define a slot 410. The lip 408 defines a top surface 409 that is spaced a distance longitudinally away from the engagement surface 416. The lip 408 defines a bottom surface 411 that is spaced a distance away from the top surface 409 in the direction of the engagement surface 416. The slot 410 extends at least partially between a first end 412 of the head 404 to a second end 414 of the head 404. The slot 410 may be parallel relative to the engagement surface 416. The slot 410 may be angled relative to the engagement surface 416. For example and as shown in FIG. 9, the slot 410 is angled relative to the engagement surface 416 where the distance D1 at the second end 414 is smaller than the distance D2, at the first end 412. The ratio of D1 to D2 may be between about 1.5:1 to about 2:1.

The head 404 defines a top surface 409 and an opposite bottom surface 417. A trunk 405 extends from the bottom surface 417 of the head 404 in a direction away from the top surface 409. Trunk 405 is shown in FIG. 9. It should be understood that the head 404 and the trunk 405 may be separate components or a single component, without departing from the spirit/scope of this disclosure. The trunk 405 may define a cross-sectional shape that is smaller than the cross-sectional shape of the head 404. In some instances, the trunk 405 may define a cross-sectional shape that is larger than the cross-sectional shape of the head 404. The head 404 and the trunk 405 may be in fluid communication with each other.

The head 404 is mounted axially with respect to the body 406. Specifically, the trunk 405 of the head 404 is mounted axially with respect to the body 406. The head 404 and the trunk 405 are rotatably coupled to the body 406 such that the head 404 and the trunk 405 are able to rotate relative to the body 406. In some instances, the body 406 may be mounted with respect to the vehicle 100. In such instances, the body 406 may be fixedly coupled to the vehicle 100 and the head 404 is rotatably coupled to the body 406. The head 404 may rotate freely with respect to the body 406 and the vehicle 100. The head 404 may be configured to rotate between about 0 degrees and about 360 degrees relative to the body 406.

The head 404 defines a first surface 418 that extends between the outer surface 407 along the first end 412. In some instances, the second end 414 of the head 404 may be planar. In other instances, as defined in FIG. 8, the second end 414 of the head 404 may be pointed or nearly pointed and defines a tip 419. The cross-sectional shape of the head 404 captured along the engagement surface 416 depicts a planar first surface 418, a pointed or blunted tip 419, and an outer surface 407 that is angled and/or arced between the first surface 418 and the tip 419. In a non-limiting example, the cross-sectional shape of the head 404 captured along the engagement surface 416 is v-shaped.

The head 404 defines at least one opening 420 that extends from the engagement surface 416 in the direction of the body 406. The at least one opening 420 is positioned at a location along the engagement surface 416 of the head 404 such that the lip 408 and the accompanying slot 410 are spaced a distance away from the at least one opening 420 in the direction of the periphery of the head 404. In some instances, the head 404 may define at least two openings 420, as depicted in FIGS. 6-9. The opening(s) 420 may be positioned in a centralized location of the head 404 along the engagement surface 416. The openings 420 extend through the head 404.

The at least one opening 420 may extend through the trunk 405 and through at least a portion of the body 406 (FIG. 9). The trunk 405 of the head 404 may be movably coupled to the body 406 using a rotary union (not shown). The rotary union is configured to transfer fluid between a fixed component, in this case the body 406, and a movably component, in this case the head 404.

The opening(s) 420 may include a liner 422 that lines at least a portion of the inner surface of the opening(s) 420. The liner 422 may extend along the entirety of the opening 420. The liner 422 may be fabricated from a material that is different from the opening 420. For example, the liner 422 may be fabricated from a polymer. The liner 422 may protect the opening 420 and/or the contents passing therethrough from each other.

In some instances, the opening(s) 420 may be configured to deliver a fluid (e.g., air) between the vehicle 100 and the trailer 150. For example, the opening(s) 420 may be configured to deliver a fluid (e.g., air) between the hitch 402 of the vehicle 100 and the kingpin 452 of the trailer 150. At least the head 404 of the hitch 402 may be fabricated from a ferrous material and the liner 422 may protect the ferrous material of the opening 420 from damage (e.g., micro-factures) that may impact the fluid passing therethrough.

The head 404 defines at least one electrical contact 424 that is positioned relative to the engagement surface 416. The electrical contact 424 may be positioned such that it is at least partially accessible from the engagement surface 416 of the head 404. Referring to FIG. 8, the electrical contact 424 is positioned along the engagement surface 416 and at least partially within the slot 410. Thus, the electrical contact 424 is positioned along the engagement surface 416 and below at least a portion of the bottom surface 411 of the lip 408.

Referring to FIGS. 8 and 9, the head 404 may include a plurality of electrical contacts 424 spaced along the engagement surface 416. For example, the plurality of electrical contacts 424 are spaced along the engagement surface 416 in proximity to the lip 408 of the head 404. The plurality of electrical contacts 424 may be evenly spaced along the engagement surface 416 in proximity to the lip 408.

The electrical contact(s) 424 may be surface mounted contacts such that the contact is flush or nearly flush with the engagement surface 416, either above or below. The electrical contact 424 is configured to electrically communicate with a corresponding electrical contact mounted with respect to the kingpin 452. In some instances, the electrical contact(s) 424 may be mounted with respect to a biasing member (e.g., spring) 425 that is positioned to bias the electrical contact 424 in the direction of the engagement surface 416 (FIG. 9). The biasing member 425 may serve to urge the electrical contact 424 to a position such that the contact is positioned above the engagement surface 416. Thus, the electrical contact 424 may be biased by the biasing member 425 in the direction of a mating electrical contact of the kingpin 452.

In some instances, a cover (not shown) may be positioned in proximity to the electrical contact 424 to overlay or protect at least a portion of the electrical contact 424 in the unused position. The cover is configured to move (e.g., slide, rotate) to a position thereby exposing the electrical contact 424. The engagement with the kingpin 452 may cause the cover (not shown) to move.

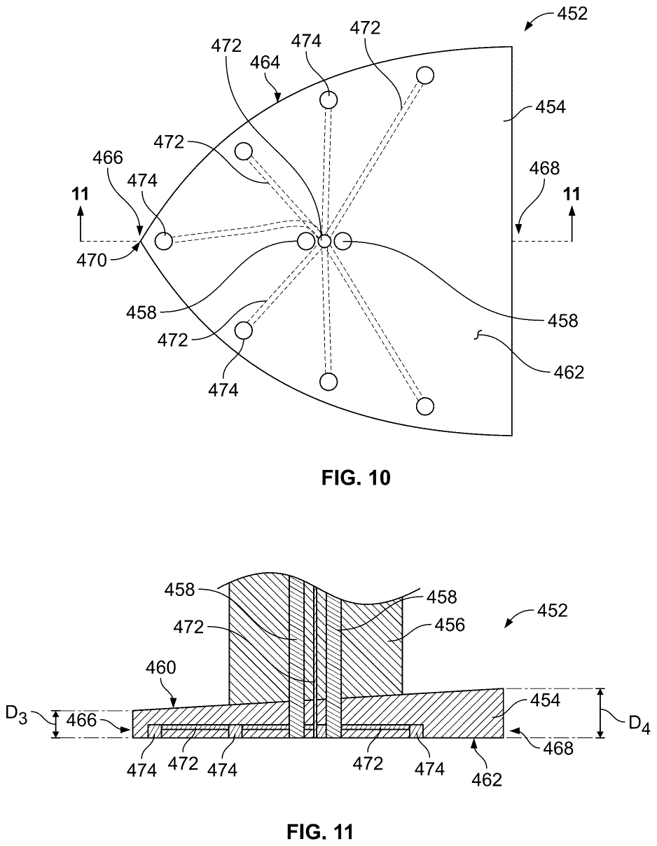

Referring to FIGS. 10 and 11, the kingpin 452 defines a body 454 and a post 456. The body 454 and the post 456 may be separate components that, when assembled, create the kingpin 452 or a may be a single component of the kingpin 452. The post 456 may be coupled to the trailer 150. For example, the kingpin 452 may be mounted to the trailer 150 such that the post 456 extends outwardly from the trailer and, in some cases, towards the ground (e.g., perpendicular to the ground). The kingpin 452 is typically positioned towards the front of the trailer 150 where the trailer 150 would couple with the vehicle 100.

The body 454 defines a top surface 460 and a bottom surface 462 opposite from the top surface 460. The body 454 defines an outer surface that connects the top surface 460 and the bottom surface 462. The body defines a first end 466 and an opposite second end 468. The body 454 is configured to interface with the hitch 402. For example, the body 454 is configured to interface with at least the head 404 of the hitch 402. The top surface 460 may be tapered relative to the bottom surface 462. For example, the top surface 460 defines a distance D3 in proximity to the first end 466 that is smaller than a distance D4 in proximity to the second end 468. The ratio of distance D3 to distance D4 may be between about 1.5:1 to about 1:2. The body defines a tip 470 positioned in proximity to the first end 466.

The kingpin 452 defines an opening 458 that extends at least partially between the post 456 and the body 454. For example, the opening 458 extends to the bottom surface 462 of the body 454. The opening may be configured to deliver a fluid (e.g., air) from an area of the trailer 150 (not shown) to the bottom surface 462 of the kingpin 452. As depicted in the figures, the kingpin defines two openings 458, however, the number of openings may vary based on the desired need.

The kingpin 452 includes an electrical wire (or the like) 472 that is configured to deliver electrical power and/or data from an area of the trailer 452 (not shown) to the kingpin 452. For example, the electrical wire 472 is positioned to extend through at least a portion of the post 456 into the body 454. The electrical wire is in electrical communication with at least one electrical contact 474 coupled to the kingpin 452. For example, the kingpin 452 may include a plurality of spaced electrical contacts 474, each in electrical communication with the electrical wire 472.

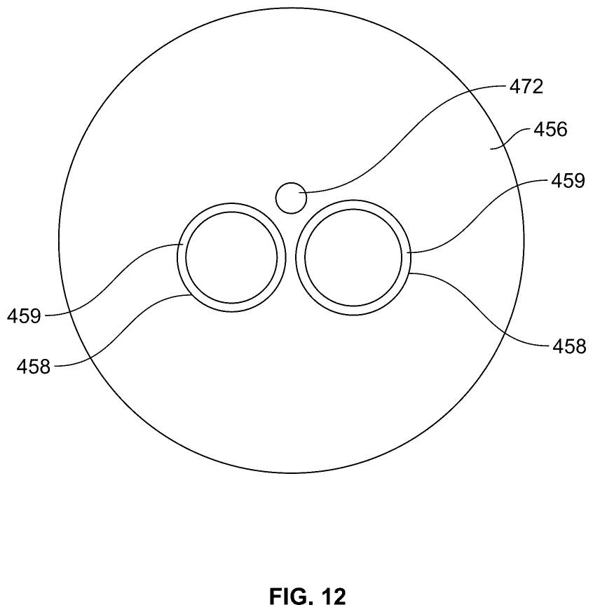

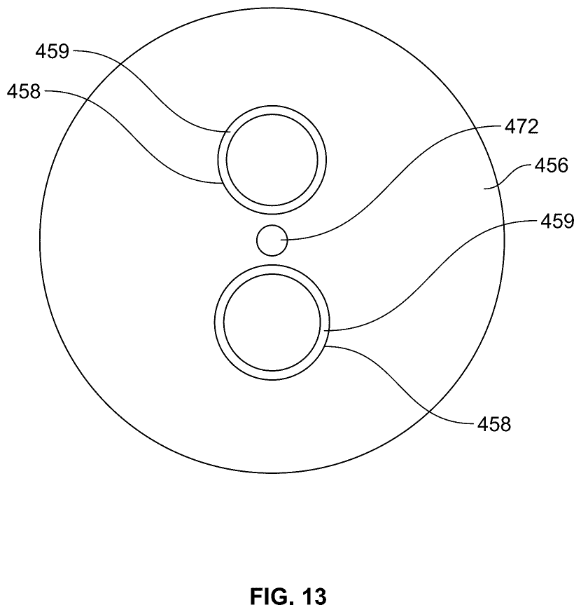

The electrical wire 472 is positioned relative to the openings 458 in a desirable arrangement. For example, the electrical wire 472 may be positioned between each opening 458 in an axial configuration, as depicted in FIGS. 6 and 13. In another arrangement, as depicted in FIG. 12, the electrical wire 472 may be positioned offset from the openings 458. The arrangement ensures that the openings 458 and the electrical wire 472 are spaced from each other, but is not intended to be limiting. Thus, the arrangement depicted in FIG. 6 may be replaced with the arrangement depicted in FIG. 12 without departing from the spirit/scope of this disclosure.

As depicted in FIGS. 12 and 13, the opening(s) 458 may include a liner 459 that lines at least a portion of the inner surface of the opening(s) 458. The liner 459 may extend along the entirety of the opening 458. The liner may be fabricated from a material that is different from the opening 458. For example, the liner 459 may be fabricated from a polymer. The liner 459 may protect the opening 458 and/or the contents passing therethrough from each other.

As depicted in FIGS. 10 and 11, the electrical wire 472 extends through at least a portion of the post 456 into the body 454. The electrical wire 472 is distributed to each of the electrical contacts 474, which are spaced around the body 454. Specifically, the electrical contacts 474 are spaced around the periphery of the body 454 and accessible from the bottom surface 462. The electrical contacts 474 are configured to electrically communicate with the electrical contacts 424 of the hitch 402. The electrical contacts 474 are configured to engage with the electrical contacts 424 of the hitch 402. Thus, the electrical contacts 474 may be positioned to engage with the electrical contacts 424 of the hitch 402 when the kingpin 452 and the hitch 402 are coupled together.

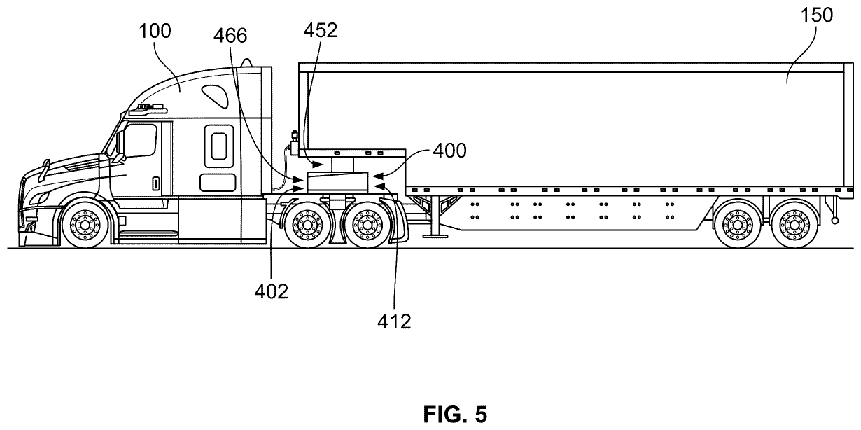

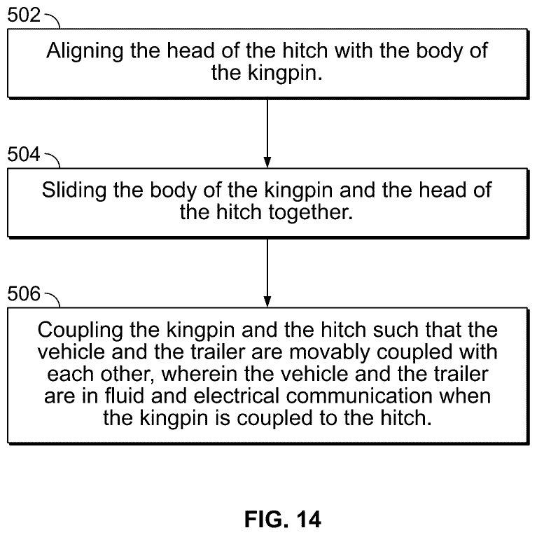

In operation and referring to FIGS. 4 and 14, the vehicle 100 includes the hitch 402 and the trailer 150 includes the kingpin 452. The hitch 402 is mounted with respect to the vehicle 100 such that the first end 412 is positioned in the direction of the trailer 150. At reference number 502, the kingpin 452 is mounted with respect to the trailer 150 such that the first end 466 is positioned in the direction of the vehicle 100. The hitch assembly 400 is configured to be assembled with minimal or no user intervention as the vehicle 100 may be fully autonomous or nearly autonomous. With the trailer 150 stationary, the vehicle 100 aligns itself to the trailer 150 such that the hitch 402 is aligned with the kingpin 452. The vehicle 100 begins to back up in the direction of the trailer 150, maintaining the alignment of the hitch 402 and the kingpin 452 as each become closer to each other. The first end 466 of the kingpin 452 becomes positioned within proximity of the first end 412 of the hitch 402. Specifically, the tip 470 of the kingpin 452 begins to cross the plane of the first surface 418 of the hitch 402. At reference number 504, the bottom surface 462 of the kingpin 452 slides along the engagement surface 416 of the hitch 402, the outer surface 464 of the kingpin 452 begins to glide in proximity to the slot 410 of the hitch 402. As the tip 470 of the kingpin 452 moves in the direction of the second end 414 of the hitch 402, the top surface 460 of the kingpin 452 moves in closer proximity to the bottom surface 411 of the lip 408. The kingpin 452 and the hitch 402 slide closer together as the kingpin 452 begins to wedge within the slot 410 of the hitch 402 such that the angled top surface 460 of the kingpin 452 wedges against the bottom surface 411 of the hitch 402. At reference number 506, joining the hitch 402 and the kingpin 452 as described herein causes the electrical contacts 424 of the hitch 402 to electrically communicate with the electrical contacts 474 of the kingpin 452 (FIG. 5). In some cases, the engagement of the kingpin 452 with the hitch 402 may cause a cover (not shown) to move and expose the electrical contacts 424. Joining the hitch 402 and the kingpin 452 causes the opening 422 of the hitch 402 to fluidly communicate with the opening 458 of the kingpin, thereby enabling a fluid to flow therethrough. FIG. 5 depicts the vehicle 100 and the trailer 150 in connection with each other using the kingpin 452 of the trailer 150 and the hitch 402 of the vehicle 100, as described herein. Once coupled, the head 404 of the hitch 402 and the kingpin 452 may rotate freely relative to the body 406. A locking mechanism (not shown) may further engage the kingpin 452 with the hitch 402 to retain the kingpin 452 and the hitch 402 in their coupled state. The locking mechanism, for example, may be a traditional locking mechanism used with existing vehicle/trailer hitches, such as, a pin, bolt, rod, or the like.

The various aspects illustrated by logical blocks, modules, circuits, processes, algorithms, and algorithms described above may be implemented as electronic hardware, software, or combinations of both. Certain disclosed components, blocks, modules, circuits, are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element recited in the singular and proceeded with the word “a” or “an” should be understood as not excluding plural elements unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A hitch assembly to couple a vehicle and a trailer, the hitch assembly comprising:
a hitch defining a head and a body, wherein the body is configured to be mounted with respect to the vehicle, the head defining a slot extending between a first end and an opposite second end and defined by at least an engagement surface; and
a kingpin defining a body mounted with respect to the trailer, wherein the body is configured to engage with the slot of the hitch and is mounted with respect to the engagement surface of the head,
wherein the vehicle and the trailer are in fluid and electrical communication when the kingpin is mounted with respect to the hitch.

2. The hitch assembly according to claim 1, wherein the slot is a tapered between the first end and the second end of the head.

3. The hitch assembly according to claim 1, wherein the distance defined by the slot in proximity to the first end is greater than the distance defined by the slot in proximity to the second end.

4. The hitch assembly according to claim 1, wherein the head defines an electrical contact coupled to the engagement surface and positioned in proximity to the slot.

5. The hitch assembly according to claim 1, wherein the hitch defines an opening positioned with respect to the engagement surface and the kingpin defines a corresponding opening, wherein engagement between the hitch and the kingpin causes the openings to align.

6. The hitch assembly according to claim 1, wherein the kingpin defines an opening and an electrical wire positioned in proximity therewith.

7. The hitch assembly according to claim 6, wherein the kingpin defines two openings and the electrical wire positioned between the two openings in an axial alignment.

8. The hitch assembly according to claim 6, wherein the kingpin defines two openings and the electrical wire positioned offset from the two openings in a triangular alignment.

9. The hitch assembly according to claim 1, wherein the hitch rotates with respect to the vehicle.

10. The hitch assembly according to claim 1, wherein the hitch and the kingpin define an opening configured to deliver a fluid therebetween, wherein the opening includes a liner.

11. The hitch assembly according to claim 1, wherein the liner is a polymer.

12. A method of connecting a trailer with a vehicle, wherein the trailer includes a kingpin and the vehicle includes a hitch, wherein the kingpin defines a post extending away from the trailer and a body coupled to the post and opposite from the trailer, wherein the hitch defines a body mounted with respect to the vehicle and a head coupled to the body and opposite from the vehicle, wherein the head of the hitch defines a slot defined at least partially by an engagement surface, the method comprising:
aligning the head of the hitch with the body of the kingpin;
sliding the body of the kingpin and the head of the hitch together; and
coupling the kingpin and the hitch such that the vehicle and the trailer are movably coupled with each other,
wherein the vehicle and the trailer are in fluid and electrical communication when the kingpin is coupled to the hitch.

13. The method according to claim 12, wherein the slot of the hitch is tapered and is configured to engage with the body of the kingpin to retain the kingpin.

14. The method according to claim 12, wherein the head of the hitch and the body of the kingpin are configured to rotate relative to the vehicle.

15. The method according to claim 12, wherein the hitch defines an opening positioned with respect to the engagement surface and the kingpin defines a corresponding opening, wherein engagement between the hitch and the kingpin causes the openings to align.

16. The method according to claim 12, wherein the hitch defines an electrical contact positioned with respect to the engagement surface and the kingpin defines an electrical contact positioned with respect to the body, wherein engagement between the hitch and the kingpin causes electrical communication between the electrical contacts.

17. A hitch assembly to couple a vehicle and a trailer, the hitch assembly comprising:
a hitch defining a head and a body, wherein the body is configured to be mounted with respect to the vehicle, the head defining a slot extending between a first end and an opposite second end and defined by at least an engagement surface, wherein the slot is tapered such that the distance of the slot relative to the engagement surface at the first end is greater than the distance of the slot relative to the engagement surface at the second end; and
a kingpin defining a body mounted with respect to the trailer, wherein the body is tapered such that the distance of the body at a first end is less than the distance of the body at an opposite second end; wherein the body is configured to engage with the slot of the hitch and is mounted with respect to the engagement surface of the head,
wherein the vehicle and the trailer are in fluid and electrical communication when the kingpin is mounted with respect to the hitch.

18. The hitch assembly according to claim 17, wherein the head of the hitch comprises a plurality of electrical contacts positioned along the engagement surface and spaced around the periphery of the head relative to the slot, wherein the body of the kingpin comprises a plurality of electrical contacts positioned along a bottom surface and spaced to correspond with the electrical contacts of the hitch.

19. The hitch assembly according to claim 17, wherein the head of the hitch and the body of the kingpin are configured to rotate relative to the vehicle.

20. The hitch assembly according to claim 17, wherein the electrical contacts of the hitch further comprise a movable cover.
